(19) United States
(12) Patent Application Publication
(10) Pub. No.: US 2020/0224133 A1
(43) Pub. Date: Jul. 16, 2020

(54) Method for Making a Fermented Beverage Comprising Hop Bine Leaves or Hop Bine Stems

(71) Applicant: Anheuser-Busch InBev S.A., Brussels (BE)

(72) Inventors: Ariane Lepas, Leuven (BE); Wolfgang Tosch, Woking (GB); Andreas Gahr, Train-St. Johann (DE)

(21) Appl. No.: 16/641,247

(22) PCT Filed: Aug. 24, 2018
(86) PCT No.: PCT/EP2018/072853

§ 371 Date: Feb. 23, 2020

(30) Foreign Application Priority Data
Aug. 24, 2017 (BE) BE2017/5583

(51) Int. Cl. C12C 7/20; C12C 3/08

(52) U.S. Cl. CPC C12C 7/205; C12C 3/085

(57) ABSTRACT

A method of making a fermented beverage, in particular a cereal-based fermented beverage, the method comprising the steps of: —Preparing a wort and boiling said wort, the boiled wort comprising a liquid fraction and a solids fraction; —Separating the liquid fraction from the solids fraction; —Fermenting the liquid fraction; —Maturing the fermented liquid fraction to obtain the fermented beverage wherein hop bine leaves and/or hop bine stems are added to the wort and maintained in contact with the liquid fraction of the wort for a period of at least 20 minutes at a temperature of ranging between 70-100° C.

### TECHNICAL FIELD

The present invention concerns a method of making a fermented beverage, in particular a malt-based fermented beverage, comprising hop bine leaves or hop bine stems as an ingredient.

### BACKGROUND FOR THE INVENTION

In the beer industry, as in many industries, a continuous challenge exists to diversification of the beer types and beer flavours. Whilst a lot of efforts are made to tweak beer tastes by varying hop varieties and beer hopping tactics (eg. dry hopping, kettle flavour hopping) resulting in beers having a specific organoleptic beer related profile, there remains a far more challenging quest for malt-based beverages that have a distinguishing flavour profile far less related or associated to typical beer related organoleptic profiles. The reason herefore being that malt-based beverages with an organoleptic profile more distant from regular beers such as lager or ales, do not emulate existing beer types but rather address to non-beer consumers.

In such quest, a lot of efforts are directed to more sweeter beer type-beverages such as ‘Kriek’, but apparently, none are directed to create a malt-based beverage having a more distinguishing profile that can be associated with champagne, white wine or aperitif type of beverages. The present invention addresses this unknown field of beer types.

In the past, the use of hop bine leaves or hop bines stems in the production of beer has been disclosed in for example U.S. Pat. Nos. 6,599,554, 7,001,638 and WO03/78562, wherein a method is described for preparing a concentrated kettle hop flavour starting from an alcohol extraction of hop bine leaves or hop bine stems. The obtained kettle hop flavour is further used for imparting hop flavours to a beer that provides an intense sweet grape aroma to the beer. It is clear that such process to obtain kettle hop flavours is very cumbersome, labour intensive and energy intensive, making it unfit for use on a large industrial scale.

Therefore, there remains a market need for beverages, in particular cereal-based fermented beverages such as beer, having a distinct organoleptic profile which can be made at a reasonable cost on an industrial scale. The present invention addresses this market need.

### SUMMARY OF THE INVENTION

The present invention is defined in the appended independent claims. Preferred embodiments are defined in the dependent claims. In particular, the present invention concerns a method of making a fermented beverage, in particular a cereal-based fermented beverage, the method comprising the steps of:
Preparing a wort and boiling said wort, the boiled wort comprising a liquid fraction and a solids fraction;
Separating the liquid fraction from the solids fraction;
Fermenting the liquid fraction;
Maturing the fermented liquid fraction to obtain the fermented beverage
   wherein hop bine leaves and/or hop bine stems are added to the wort and maintained in contact with the liquid fraction of the wort for a period of at least 20 minutes at a temperature of ranging between 70-100° C.

The present invention also concerns a fermented beverage comprising thiol-conjugated cysteine and thiol-conjugated γ-glutamylcysteine, the ratio of thiol-conjugated cysteine/thiol-conjugated γ-glutamylcysteine being comprised in a range of 4 to 1, preferably in a range of 2.5 to 1.

### Definitions

Wort: in beer production, wort is a liquid obtained by mashing malted barley and/or cereal adjuncts in water, followed by filtration, the permeate of the filtration is defined as wort. Apart from the permeate, the wort can be supplemented with hops or other flavour imparting solids, additives such as metal ions or water hardness correcting ions, pH adjusting additives, etc. and/or can be diluted with water. In cider production, wort or must is obtained by mashing pieces of fruit such as apple in water. As is the case for beer, cider wort may also be supplemented with flavour imparting solids, additives such as metal ions or water hardness correcting ions, pH adjusting additives, etc. For the sake of this invention, wort is defined as beer wort or cider wort both with and without one or more supplemented solids or additives.

Whirlpool: During wort boiling, solids added to the wort and proteins that disintegrated during boiling need to be separated from the wort. There are two main options for separating the solids (hot trub) from the wort, a first option based on filtration and a second option based on sedimentation. A whirlpool is a vessel wherein the solids are allowed to separate from the liquid wort by sedimentation, ideally, as the word whirlpool suggests, comprising creating a whirlpool in the wort, such that solids are separated from the wort liquid by both centrifugal and gravity forces, resulting in the formation of a hot trub cone centrally in the whirlpool vessel. The clarified wort liquid can subsequently be transferred from the whirlpool to a fermentation tank through a syphon. For the sake of this invention, the term whirlpool is defined as a vessel wherein the hot trub is separated from the liquid wort by sedimentation and preferably by a combination of gravity and centrifugal forces.

Hop leaves solids fraction: The hop leaves solids fraction is determined by kilned hop bine leaves with or without stems (below 20% moisture content), milled into particles with a size range between 0.1-10 mm and stored into vacuum sealed packages.

Late stage of fermentation: Beer and cider fermentation typically comprise different stages, a first stage or lag stage after pitching of the yeast and including the pitching of the yeast to the wort; a second stage or exponential growth phase, wherein the yeast digests most of the sugars and flavours such as esters, higher alcohols and sulphur compounds are formed together with ethanol; and a third stage or stationary yeast growth phase, wherein the yeast reabsorbs and reduce diacetyl and yeast cells start to settle out. When diacetyl levels in the beer are sufficiently low, the fermented beer is cooled, forcing most of the yeast to settle out. For the sake of this invention a late stage of fermentation is defined as any point in time of the fermentation process after the start of the stationary growth phase.

### DETAILED DESCRIPTION OF A PREFERRED EMBODIMENT

The present invention concerns a beverage, in particular a cereal-based fermented beverage having a flavour profile comprising notes of white wine and ideally lacking harsh vegetative flavour notes. It has been found that a beverage having such flavour profile can be made by (a) preparing a wort and boiling said wort, the boiled wort comprising a liquid fraction and a solids fraction; (b) adding hop bine leaves and/or hop bine stems to the wort and maintaining the hop bine leaves and/or hop bine stems in contact with the liquid fraction of the wort at a temperature of between 70-100° C. for at least 20 minutes, thereby allowing extraction of flavour precursors such as thiols S-conjugates from the hop material into the liquid fraction; (c) separating the liquid fraction from the solid fraction and the hop bine leaves and/or stems; and subsequently (d) fermenting the liquid fraction; prior to (e) maturing the fermented liquid fraction to obtain the fermented beverage.

By addition of the hop bine leaves and/or hop bine stems to the wort, extraction of the flavour precursors such as thiols S-conjugates from the hop material into the liquid fraction is done in the absence of ethanol.

To facilitate extraction and to facilitate maintaining the hop bine leave and/or stems in suspension during extraction, the hop material is grinded or milled to particles having a maximal dimension of 0.1 to 10 mm, preferably 5 to 10 mm. The load of hop bine leaves and/or hop bine stems added to the wort is clearly dependent on the flavour potential of the hop material and on the desired hopping effect. For the present invention the hop bine leaves and/or hop bine stems are preferably dosed in the wort in a range 10 to 1000 g of hop leave solids and/or hop stem solids per hectolitre of wort liquid fraction.

The hop bine leaves and/or stems can be processed immediately after harvesting, yet the hop material can also be dried (kilned) to reduce the water content to a range between 5 and 20 w %, more preferably between 8 and 12 w %.

Examples of hop plant varieties from which the hop bine leaves and/or stems can be collected are Southern Passion, Southern Promise, Southern Star, African Queen (J17) and admixtures thereof.

Apart from the addition of the hop bine leaves and/or stems to the wort, further hopping during the beverage production is not excluded, as such dry hopping of the fermented beverage with either hop bine leaves, hop bine stems, hop cones and/or admixtures thereof are considered a good option to further tweak the organoleptic profile of the resulting beverage.

The wort to which the hop material is added is preferably prepared starting from barley malt and, optionally, one or more adjuncts.

The beverage (beer) obtained by such method typically comprises cysteine-3-mercaptohexan-1-ol (C3MH) and γ-glutamylcysteine-3-mercaptohexan-1-ol (GC3MH) in a ratio comprised in a range of 4 to 1, preferably in a range of 2.5 to 1 and comprises in a concentration of at least 30 ppb, preferably at least 40 ppb.

Without being bound to any theory, it is believed that the high GC3MH levels in the beverage (beer) result in a more subtle release of 3-mercaptohexan-1-ol (3MH) during consumption of the beverage, potentially by enzymatic degradation or microflora in the mouth of the consumer that as such may experience a prolonged and more subtle taste evolution during consumption. Furthermore, as hop bines contain only small amounts or even no hop oils, potential vegetative and typically harsh flavour components lack in the beverage, increasing the pleasant flavour experience for a consumer.

According to an alternative embodiment, the fermented beverage prepared by the addition of hop bine leaves and/or hop bine stems during the whirlpool or during wort boilkng, can be further dry-hopped with either hop pellets or other hop bine material to increase the concentration of volatile flavour components and flavour precursors in the beverage.

According to another alternative embodiment, the beverage is a so-called barley wine having an alcohol content of 10% ABV or higher, prepared by a method according to the present invention.

### EXAMPLES

As an example of a process according to the present invention, 4 varieties of hop bine leaves were handpicked (Southern Promise, Southern Star, Southern Passion and African Queen) to a total of 4150 kg (wet weight) of hop bine leaves. The leaves were subsequently kilned (just like regular hops) to achieve a water content of 7-9%. The kilned leaves were milled into particles having a mean size (largest dimension) of 5 to 10 mm resulting in a total of 830 kg hop leave material.

A wort was prepared starting from approximately 70 w % wheat malt and 30 w % of a 50:50 mixture of rice and corn adjuncts by mashing and subsequent filtration. The wort was transferred to a wort kettle, HTU pellet hops were added to the wort in a dosage of 3.2 g alpha acids per hl wort and boiled. After boiling, the wort was transferred to a whirlpool vessel, where under whirlpool conditions 600 g/hl of the hop leave material was added to the wort and maintained in contact with the wort for a period of 20 minutes. After clarification, the wort liquid was transferred to a fermentation tank and pitched with an ale yeast. After fermentation, the beer was dry hopped with Kazbek and Hallertau Blanc hops (50:50 ratio-300 g/hl).

The final beer was adjusted to have an alcohol content of 6.5% ABV, a bitterness of IBU 20, 5.0 g/I CO2, a pH of 4.3 and a hazy unfiltered visual character. The beverage comprised 50 ppb of GC3MH and a C3MH/GC3MH ratio of approximately 2.3. A taste panel described the beer as passion fruit, grapefruit, lemon, orange, mandarin, ripe/tropical fruity notes and white wine notes.

In a second trial, the same wort was fermented with an lager type of yeast and adjusted to the same product specifications in terms of ABV, IBU and CO2 content. In this case a taste panel described the beer as tangy, light phenolic, citrusy with typical Riesling notes.

In a third example a wort was prepared starting from approximately 10 w % wheat malt and 50 w % pale malt and 40% specialty malts by mashing and subsequent filtration. The wort was transferred to a wort kettle, HTU pellet hops were added to the wort in a dosage of 3.2 g alpha acids per hl wort and boiled. After boiling, the wort was transferred to a whirlpool vessel, where under whirlpool conditions 400 g/hl of the hop leave material was added to the wort and maintained in contact with the wort for a period of 20 minutes. After clarification, the wort liquid was transferred to a fermentation tank and pitched with an ale yeast. The fermented beverage was adjusted to an ABV of 10% and allowed to cold-age for 3 weeks. The final beverage was assessed as more sessionable than a similar control brew without hop bine addition.

1. A method of making a fermented beverage, in particular a cereal-based fermented beverage, the method comprising the steps of:
preparing a wort and boiling said wort, the boiled wort comprising a liquid fraction and a solids fraction;
separating the liquid fraction from the solids fraction;
fermenting the liquid fraction; and
maturing the fermented liquid fraction to obtain the fermented beverage characterized in that hop bine leaves and/or hop bine stems are added to the wort and maintained in contact with the liquid fraction of the wort for a period of at least 20 minutes at a temperature of ranging between 70-100° C.

2. The method according to claim 1, wherein the hop bine leaves and/or hop bine stems are dosed in the wort in a range of 10 to 1000 g hop leave solids per hectolitre wort.

3. The method according to claim 1, wherein the hop bine leaves and/or hop bine stems are kilned to reduce the water content to a range between 5 and 20%.

4. The method according to claim 1, wherein the kilned hop bine leaves and/or hop bine stems are milled or ground to particles with a maximal dimension of 0.1 to 10 mm.

5. The method according to claim 1, wherein the hop bine leaves and/or hop bine stems are collected from hop plant varieties from the group chosen from Southern Passion, Southern Promise, Southern Star, African Queen (J17) and admixtures thereof.

6. The method according to claim 1, comprising dry hopping of the liquid fraction during or after fermentation.

7. The method according to claim 1, the wort being prepared starting from malted barley and, optionally one or more adjuncts.

8. A fermented beverage comprising thiol-conjugated cysteine and thiol-conjugated γ-glutamylcysteine, the ratio of thiol-conjugated cysteine/thiol-conjugated γ-glutamylcysteine being comprised in a range of 4 to 1.

9. The beverage according to claim 8, comprising cysteine-3-mercaptohexan-1-ol and γ-glutamylcysteine-3-mercaptohexan-1-ol in a ratio comprised in a range of 4 to 1.

10. The beverage according to claim 8, comprising γ-glutamylcysteine-3-mercaptohexan-1-ol in a concentration of at least 30 ppb.

11. The beverage according to any of claim 8, comprising less than 100 ppb of hop oils, the hop oils calculated as a sum of the concentrations of linalool, a-humulene, geraniol and myrcene.

12. The beverage according to claim 8 being a cereal-based fermented beverage.

13. The beverage according to claim 8 having an alcohol content ranging between 1 and 20% ABV.

14. The method according to claim 3, wherein the range for the water content is between 8-12%.

15. The method according to claim 4, wherein the maximal dimension is from 5-10 mm.

16. The beverage according to claim 8, wherein the ratio of thiol-conjugated cysteine/thiol-conjugated γ-glutamylcysteineis is in a range of 2.5 to 1.

17. The beverage according to claim 9, wherein the ratio of cysteine-3-mercaptohexan-1-ol and γ-glutamylcysteine-3-mercaptohexan-1-ol is in a range of 2.5 to 1.

18. The beverage according to claim 10, wherein the concentration is at least 40 ppb.

19. The beverage according to claim 11, comprising less than 40 ppb of the hop oils.
